(19) United States
(12) Patent Application Publication
(10) Pub. No.: US 2019/0195293 A1
(43) Pub. Date: Jun. 27, 2019

(54) FRICTION PLATE

(71) Applicant: Miba Frictec GmbH, Laakirchen (AT)

(72) Inventors: Volker FOEGE, Bad Ischl (AT); Gabriel HEER, Gschwandt (AT); Falk NICKEL, Gmunden (AT)

(73) Assignee: Miba Frictec GmbH, Laakirchen (AT)

(21) Appl. No.: 16/328,031

(22) PCT Filed: Sep. 7, 2017
(86) PCT No.: PCT/AT2017/060215

§ 371 Date: Feb. 25, 2019

(30) Foreign Application Priority Data
Sep. 12, 2016 (AT) A 50808/2016

(51) Int. Cl. F16D 13/64

(52) U.S. Cl. CPC F16D 13/648

(57) ABSTRACT

The invention relates to a friction plate (10) having a ring-shaped plate body (4, 9), which is closed in the circumferential direction (13), and has multiple recesses, and is delimited by a radially inner face surface (11) and a radially outer face surface (24). The recesses (14) are configured in slot shape, at least in part, and have multiple partial regions (20 to 23), wherein at least two partial regions (20 to 23) run in different directions relative to one another, and wherein furthermore, the slot-shaped recesses (14) are configured at a distance from the radially inner face surface (11) and the radially outer face surface (24).

The invention relates to a friction plate having a ring-shaped plate body, which is closed in the circumferential direction, on which body at least one friction coating is disposed, if necessary, and wherein the plate body has multiple recesses. Furthermore, the invention relates to a plate package comprising multiple friction plates disposed one behind the other in the axial direction.

Friction plates for plate friction systems are known as such from the state of the art. These can be structured with or without a friction coating, depending on whether an outer or an inner plate is involved. The friction plates are situated on plate carriers and are brought into a frictional lock with one another, as necessary, by means of an activation apparatus.

Friction plates with damping are also already known from the state of the art. Primarily, however, in this regard vibration damping stands in the foreground of considerations.

It is the task of the present invention to make available a plate friction system having reduced noise development.

This task is accomplished, in the case of the friction plate mentioned initially, in that the recesses are configured in slot shape, at least in part, and have multiple partial regions, wherein at least two partial regions run in different directions relative to one another, and wherein furthermore, the recesses are configured at a distance from the radially inner face surface and the radially outer face surface and/or that in the embodiment variant of the plate body with a friction coating, the slot-shaped recesses are disposed in the friction coating and the plate body in this embodiment variant is free of recesses, if necessary. Furthermore, the task is accomplished with a plate package that has at least one friction plate according to the invention.

The “sound body” of the friction plate is “divided” into smaller, acoustically independent bodies by means of the slot-shaped recesses, and thereby the noise behavior of the friction plate changes to a lower level. The overall noise level thereby drops. Therefore the noise development is already influenced in this way, so that additional damping devices or damping elements are not necessary. Furthermore, body vibrations of the friction plate are partially reflected and scattered at the side walls of the slots, so that the vibrations hinder themselves by means of a phase shift in the friction plate. The noise damping plate can be produced in simple manner, so that it can be easily implemented even on a large technical scale. Furthermore, very simple adaptation to different purposes of use of the friction plate can take place by means of the placement and the configuration of the slot-shaped recesses. In other words, system damping is possible with the friction plate.

According to a preferred embodiment variant, it is provided that the recess are configured as perforations. In this way, noise damping can be further improved. For example, it is possible, in this way, that the region around the slot-shaped recesses, which can be structured in tongue shape, for example, on the basis of the configuration of the slot-shaped recesses, are put into vibration, wherein these vibrations can take place at a frequency that lead to noise reduction in the overall frequency range of the noise development of the friction plate.

According to another embodiment variant, it can also be provided that the slot-shaped recesses are interrupted by at least one further recess, not slot-shaped, in particular by a further perforation. These larger recesses influence the flow of coolant. In particular, the coolant can flow through them in the embodiment as further perforations. As a result, the coolant, for example a cooling oil, not only contributes to cooling of the friction plate, but rather can also be used, in addition, for noise damping.

In order to be able to adapt the friction plate better to the most varied applications, and to not reduce the above effects as a result, it can be provided, according to different embodiment variants of the friction plate, that a friction coating is disposed on the plate body, and that at least part of the recesses is configured underneath the friction coating in the radial direction, and/or that a friction coating is disposed on the plate body and that at least part of the recesses is configured underneath the friction coating in the axial direction, and/or that a friction coating is disposed on the plate body and that at least part of the recesses extends continuously through the friction coating and the plate body, in the axial direction.

It can furthermore be advantageous if at least part of the recesses is filled, at least in part, with a material that demonstrates lower rigidity than the plate body. In this way, the result can be achieved that the vibration behavior of the acoustically active bodies of the friction plate cannot develop fully due to the filling, but rather the vibrations influence or hinder one another. In this way, a further reduction of the noise development of the friction plate can be achieved.

For a better understanding of the invention, it will be explained in greater detail, using the following figures.

The figures show, each in a (greatly) simplified, schematic representation:

FIG. 1 a detail of a plate package according to the state of the art in a side view;

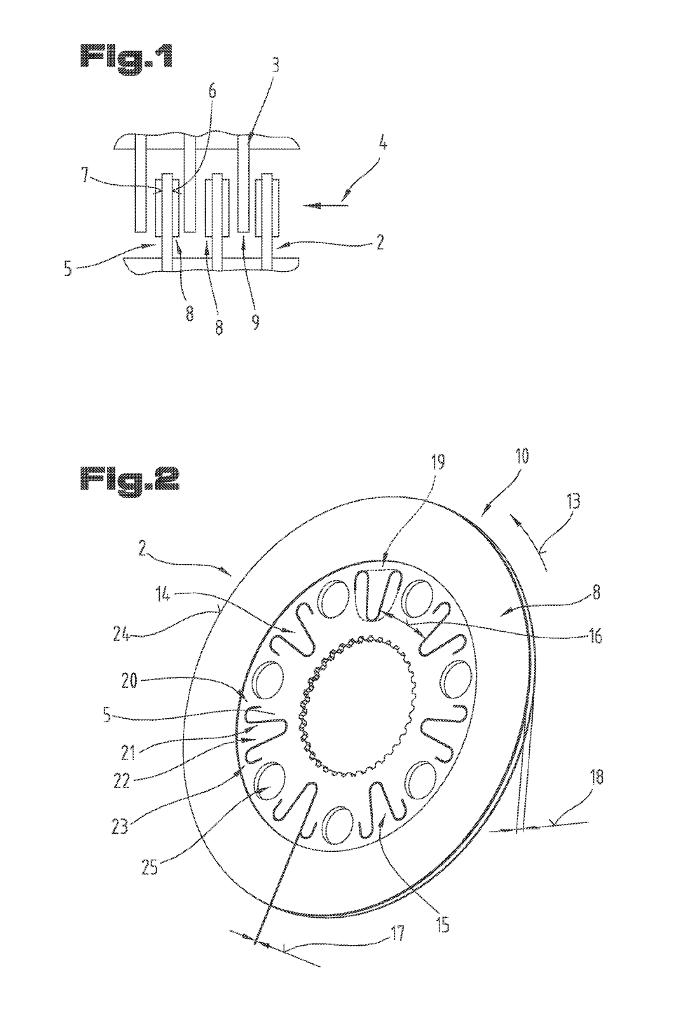

FIG. 2 a first embodiment variant of the friction plate in a slanted view;

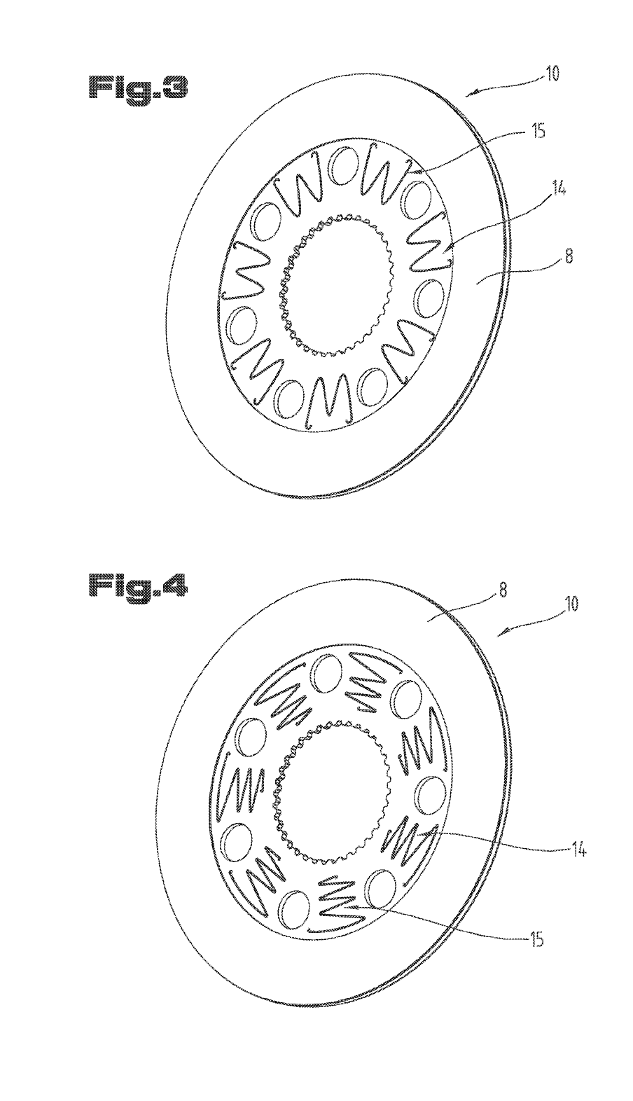

FIG. 3 a second embodiment variant of the friction plate in a slanted view;

FIG. 4 a third embodiment variant of the friction plate in a slanted view;

FIG. 5 a fourth embodiment variant of the friction plate in a slanted view;

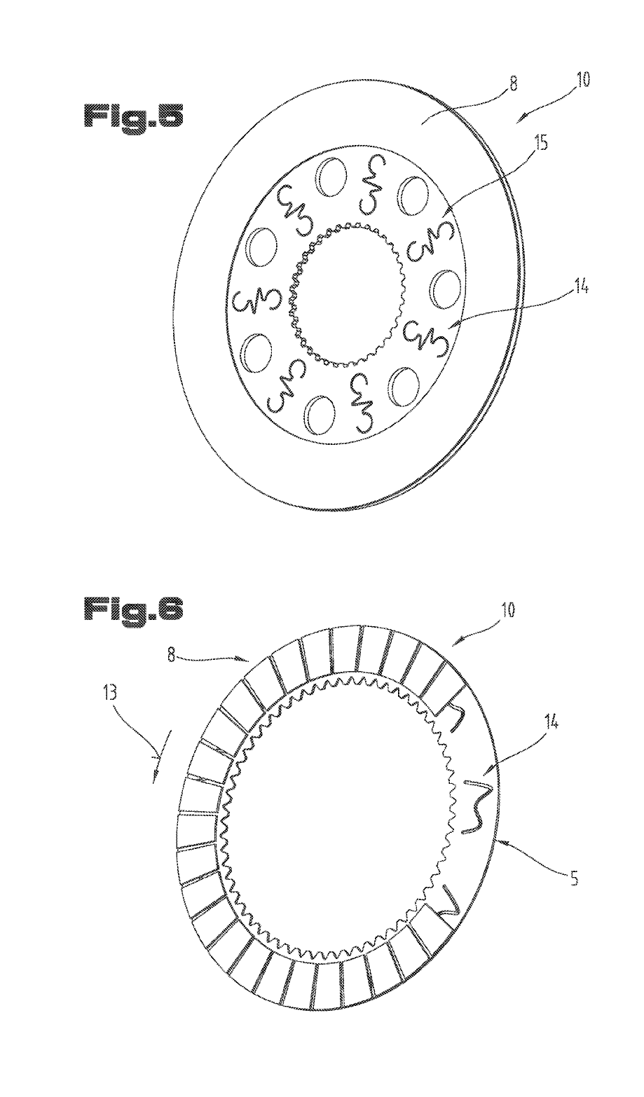

FIG. 6 a fifth embodiment variant of the friction plate in a slanted view;

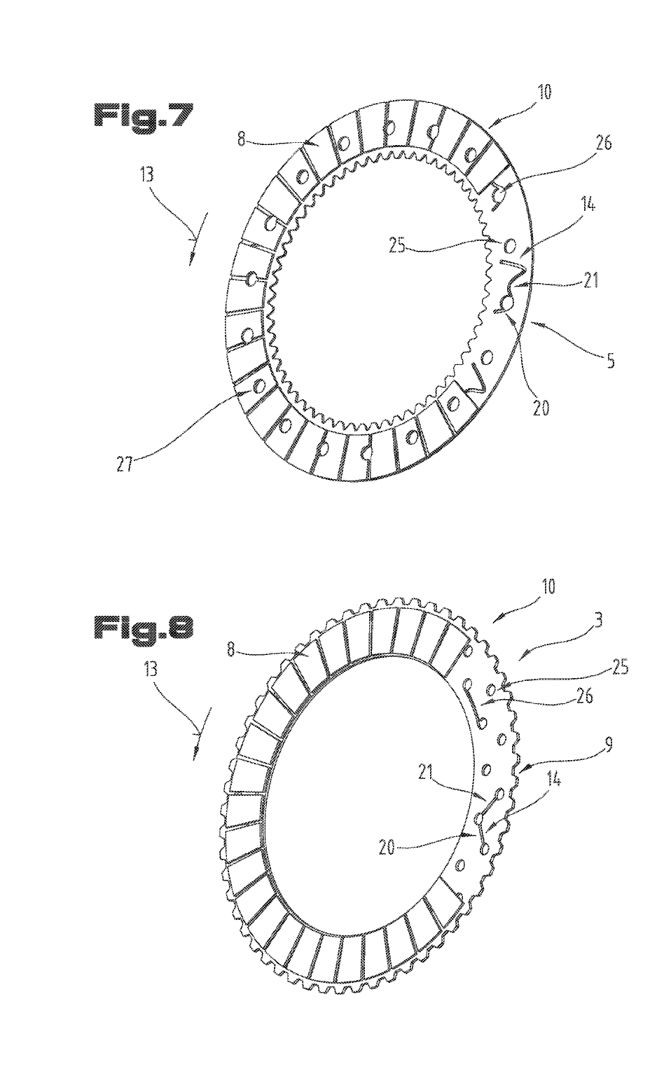

FIG. 7 a sixth embodiment variant of the friction plate in a slanted view;

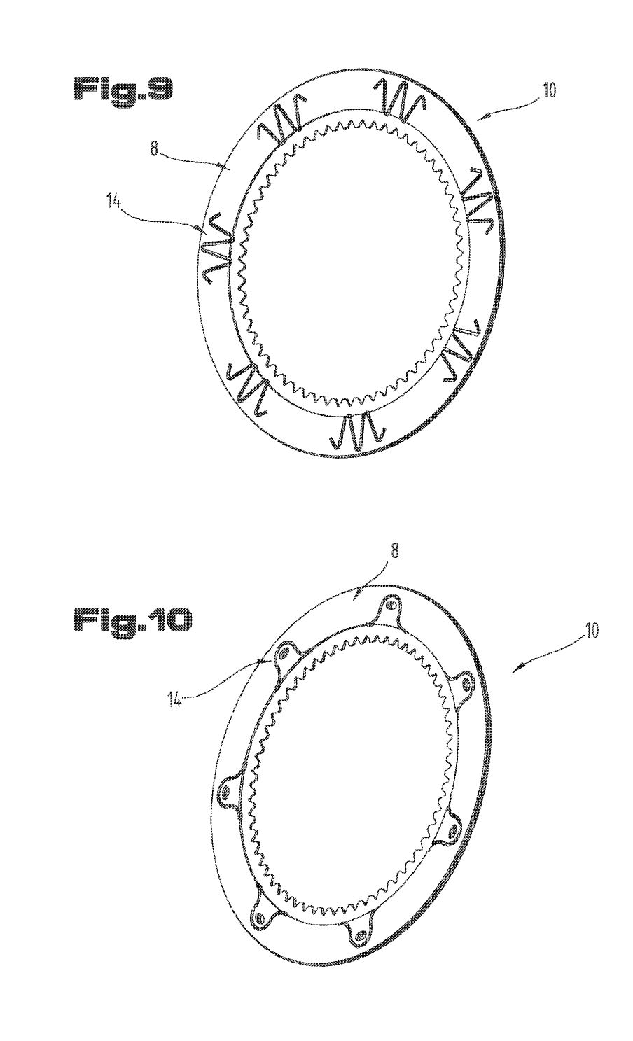

FIG. 8 a seventh embodiment variant of the friction plate in a slanted view;

FIG. 9 an eighth embodiment variant of the friction plate in a slanted view;

FIG. 10 a ninth embodiment variant of the friction plate in a slanted view.

As an introduction, it should be stated that in the different embodiments described, the same parts are provided with the same reference symbols or the same component designations, wherein the disclosures contained in the description as a whole can be applied analogously to the same parts having the same reference symbols or the same component designations. Also, position information selected in the description, such as at the top, at the bottom, on the side, etc., for example, relates to the figure being directly described and shown, and must be transferred to the new position in the event of a change in position.

In FIG. 1, a detail of a known plate package 1 is shown. The plate package 1 has multiple inner plates 2 and multiple outer plates 3, which can also be referred to as friction plates. The inner plates 2 are disposed alternating with the outer plates 3 in an axial direction 4. The inner plates 2 are adjustable relative to the outer plates 3 in the axial direction 4, by way of a corresponding activation mechanism, so that a frictional lock is formed between the inner plates 2 and the outer plates 3.

The inner plates 2 have an at least approximately ring-shaped plate body 5 having a first surface 6 and a second surface 7 that lies opposite the first in the axial direction 4. At least one friction coating 8 is disposed on the first and/or the second surface 6, 7, in each instance. The inner plates 2 are therefore so-called coated plates.

The friction coatings 8 can be configured in accordance with the state of the art.

It can also be provided that the inner plates 2 do not have any friction coatings 8.

The outer plates 3 also have an at least approximately ring-shaped plate body 9, which is, however, free of friction coatings. The outer plates 3 are therefore the so-called counter-plates, which can be brought into a frictional lock with the friction coatings 8 of the inner plates 2. However, the possibility also exists that the friction coatings 8 are disposed on the outer plates 3, in particular if no friction coatings 8 are disposed on the inner plates 2.

Preferably, the inner plates 2 and the outer plates 3 consist of a steel or comprise it. However, they can also consist of a different suitable material, in particular a metallic material. For example, the inner plates 2 can consist of a resin-bonded composite material or of a sintered material, as is already known. The friction coatings 8 disposed on the inner plates can consist, for example, of a carbon material or of a resin-bonded, if necessary fiber-reinforced paper coating or a resin-bonded coating or of a sintered material. Such friction coatings are known from the state of the art, so that reference is made to this. It is also possible that the friction coatings 8 are disposed on a carrier (the aforementioned plate body 5). The carrier preferably consists of steel or of another suitable material.

This fundamental structure of a plate package 1 is known from the state of the art. For this reason, reference is made to this relevant state of the art for further details.

The plate package 1 is part of a plate friction system, for example of a (wet-running) plate clutch, a brake, a holding apparatus, a differential lock, etc.

In FIG. 2, a first embodiment variant of a friction plate 10 is shown, as it is used in the plate package 1 according to FIG. 1. Specifically, an inner plate 2 in accordance with the representation in FIG. 1 is shown. However, the friction plate 10 can also be an outer plate 3 (FIG. 1), wherein in this case, it does not have a friction coating 8.

The friction plate 10 is particularly provided for so-called wet operation.

The friction plate 10 can have at least one driver element 12, for example in the form of an inner gearing, on a radially inner face surface 11.

It should be mentioned at this point that the outer plates 3 can also have at least one driver element on a radially outer face surface.

A torque-proof connection with a further component of the plate friction system, for example a shaft in the case of the inner plates 2 or the housing of the plate friction system in the case of the outer plates 3, can be produced by way of the driver elements, as is already known.

It is also possible that the inner plates 2 or the outer plates 3 are configured as so-called free-flying plates, in other words do not have any such driver elements, as is already known.

The plate body 5 of the friction plate 10 is configured to be closed in a circumferential direction 11.

At this point, it should be pointed out that in the following, only the plate body 5 is discussed. In the event that the friction plate is an outer plate 3 (FIG. 1), the following explanations regarding the plate body 5 can also be applied to the plate body 9 of the outer plate, if this body is also configured according to the invention.

Preferably, the plate body 5 is configured in one piece. However, it is also possible that the plate body 5 is composed of multiple segments that are connected with one another.

Multiple recesses 14 are provided or configured in the plate body 5 of the friction plate 10. The recesses 14 are structured as perforations, according to a preferred embodiment variant, in other words extend continuously through the plate body 5 in the axial direction 4 (FIG. 1).

The recesses 14 are configured, at least in part, in slot shape, in other words as slots 15. In the embodiment variant shown, the recesses are structured as slots 15 in their entirety.

In the embodiment variant of the friction plate 10 shown in FIG. 2, seven recesses 14 or perforations are provided. However, it should be pointed out that this number of recesses 14 should not be viewed as being restrictive. Instead, the number of recesses 14 can amount to between 4 and 40. The precise number is based on the respective geometry and the intended use of the friction plate 10, in other words, for example, whether it is used in a brake or in a clutch, and can be easily determined with a few experiments by a person skilled in the art, based on the teaching of the present description.

In the embodiment variant of the friction plate 10 that is shown, the recesses 14 are disposed uniformly distributed distributed in the plate body 4. However, the possibility also exists, although this is not preferred, that the recesses 13 are disposed non-uniformly distributed in the circumferential direction 13 of the friction plate 10. A distance 16 between two recesses 14 that are adjacent in the circumferential direction 13 can therefore be the same for all the recesses 14 or it can be smaller or greater between at least two adjacent recesses 14 than between the remaining recesses 14, which are adjacent, in each instance.

The slot-shaped recesses 14 have a clearly greater total length in comparison with a width 17 (viewed in the front view in the direction of the axial direction 4). In particular, the total length can generally, within the scope of the invention, by a value greater, selected from a range of 5 times to 50 times, in particular from a range of 10 times to 40 times the width 17.

The width 17 of the slot-shaped recesses 14 can generally be selected, within the scope of the invention, from a range of 50% to 150%, in particular from a range of 50% to 100%, of a thickness 18 of the plate body 5 (in other words without friction coatings 8), viewed in the direction of the axial direction 4.

As is evident from FIG. 2, the slot-shaped recesses 14 do not run in a straight line, but rather have a multiple reversal of direction during the course of their total length. In the concrete exemplary embodiment, the slot-shaped recesses have a triple reversal of direction. Preferably, in this regard, an imaginary sheath 19—viewed in the direction of the axial direction 4—generally encloses a surface area that amounts to between 1% and 30%, in particular between 5% and 20%, of the total surface area of the plate body 5 (viewed in the same direction), within the scope of the invention. In this regard, the sheath 19 is the figure that surrounds a slot-shaped recess 14 on its outer circumference, as indicated with a broken line in FIG. 2, by analogy to a sheathing circle.

The slot-shaped recesses 14 therefore preferably have multiple partial regions (in general within the scope of the invention), which run in different directions from one another. In the embodiment variant of the friction plate according to FIG. 2, the slot-shaped recesses 14 have four partial regions 20 to 23, which are disposed in such a manner that the slot-shaped recesses are configured approximately in V shape, viewed in the direction of the axial direction 4 (FIG. 1), wherein the end regions are configured to be extended and running radially inward, as is evident from FIG. 2. Transitions between the partial regions 20 to 23 are preferably structured to be rounded (in general within the scope of the invention).

Within the scope of the invention, the slot-shaped recesses 14 are generally disposed or configured at a distance not only from the radially inner face surface 11 but also from a radially outer face surface 24 of the plate body 5. The smallest distance from the radially inner face surface 11 can amount to between 1% and 40%, in particular between 5% and 30% of the outside diameter of the friction plate 10. The smallest distance from the radially outer face surface 24 can amount to between 1% and 40%, in particular between 5% and 30% of the outside diameter of the friction plate 10.

Aside from the slot-shaped recesses 14, the plate body 5 can also have additional perforations 25, which served for oil guidance and thereby for cooling of the friction plate. The perforations 25 pass through the plate body 5 in the axial direction 4 (FIG. 1).

Within the scope of the invention, one or more, for example similar inner plates 2 and/or one or more, for example all of the outer plates 3 (FIG. 1) can be formed by the friction plate 10, in general.

In FIGS. 3 to 10, different embodiment variants of the friction plate 10 are shown, which can be independent, if necessary, wherein the same reference symbols or component designations as in FIGS. 1 and 2 are used for the same parts. In order to avoid unnecessary repetition, reference is therefore made to the above, detailed description of these parts, i.e. this is pointed out, and therefore these can be considered to apply to the following embodiment variants of the friction plate 10.

With the representations in FIGS. 3 to 5, it is intended to make it clear that the slot-shaped recesses 14, i.e. the slots 15 can have different progressions, so as to thereby be able to influence the reduction of noises in the region of the friction plate 10. However, it should be pointed out once again that the embodiments of the slot-shaped recesses that are shown in concrete terms is not to be understood as being restrictive.

For example, the slot-shaped recesses 14, viewed in the direction of the axial direction 4, in each instance (FIG. 1), can be configured, at least approximately, in the shape of a W (FIG. 3) or at least approximately corresponding to the image of a helical spring (viewed in a side view) (FIG. 4 and FIG. 5, in the case of the latter, the small hooks).

In general, it should be noted that the slot-shaped recesses 14 of a friction plate 10 can also have different shapes from one another. It is furthermore possible, in general, that the slot-shaped recesses 14 can be disposed on different radial heights in the friction plate 10, although they are shown as lying on the same radial height, in each instance, in the representations of FIGS. 2 to 10.

The embodiment variants of the friction plate 10 according to FIGS. 2 to 5 have in common that at least a part of the slot-shaped recesses 14, in particular all of them, is disposed or configured underneath the friction coating 8 in the radial direction. The expression “at least a part” means a number of the total number of recesses 14, so that therefore all partial regions 20 to 23 of a recess 14 are disposed or configured underneath the friction coating 8 in the radial direction. However, it is also possible that not all the partial regions 20 to 23 of a recess 14 are disposed or configured underneath the friction coating 8 in the radial direction, but rather one or more partial region(s) 20 to 23 of a recess is/are disposed or configured underneath the at least one friction coating 8 in the axial direction 4 (FIG. 1).

FIGS. 6 to 8 show embodiment variants of the friction plate 10 in which at least a part of the slot-shaped recesses 14 is disposed or configured underneath the at least one friction coating 8 in the axial direction 4 (FIG. 1). What was explained above applies with regard to “at least a part.”

In FIGS. 6 to 8, part of the friction coating 8 was left out, so as to make the slot-shaped recesses 14 visible. Of course, the friction plate 19 also has the friction coating 8 in these regions.

It can furthermore be seen from these FIGS. 6 to 8 that the friction coating 8 can also be formed by multiple friction coating segments disposed next to one another and spaced apart from one another in the circumferential direction 13.

In the case of these embodiment variants of the friction plate 10, the slot-shaped recesses 14 (or at least a part of the slot-shaped recesses 14, i.e. at least some slot-shaped recesses 14) are covered by the friction coating 8 on one side or by the friction coatings 8 on both sides, in particular covered in their entirety. In this regard, the adhesive with which the at least one friction coating 8 is connected with the plate body 5 or 9 in the case of FIG. 8, which shows an outer plate 3, will fill the slot-shaped recesses 14 at least in part, particularly in their entirety. In this way, a flow of force passing over the slot-shaped recesses 14 is achieved, wherein the buildup of vibrations having the same phase is prevented, however, due to the different materials of plate body 5, 9 and adhesive. The vibrations hinder one another reciprocally, and thereby noise reduction in the operation of the friction plate 10 is achieved.

At least a part of the slot-shaped recesses 14, in particular all of them, can is filled, within the scope of the invention, with with a material that has a lower rigidity than the plate body 5, 9, at least in part, in particular in their entirety, in general. This material can be selected, for example, from a group comprising or consisting of polyurethane, elastomers, such as natural rubber, for example, (carboxylated) nitrile/butadiene rubber, isoprene rubber, silicone elastomers, etc.

In this connection, it should be pointed out that the slot-shaped recesses 14 of these embodiment variants of the friction plate 10 can also be filled, at least in part, by the friction coating 8 or the friction coatings 8. For example, this can be achieved in that the friction coating 8 or the friction coatings 8 are pressed into the slot-shaped recesses 14. In this way, a shape lock can be achieved between the plate body 4, 9 and the friction coating 8 or the friction coatings 8, which can improve the composite strength between friction coating 8 and plate body 4, 9.

As is evident from FIGS. 7 and 8, it can be provided, according to another embodiment variant of the friction plate 10, the at least a part, in particular all of the slot-shaped recesses 14 can be interrupted by at least one further, non-slot-shaped recess 26, in particular a further perforation. In this regard, these further recesses 16 can be configured or disposed in the course of the slot-shaped recesses 14, in other words between two partial regions 20, 21, or on at least one end, in particular both ends of the slot-shaped recesses 14. In this regard, it can be provided that the slot-shaped recesses 14 are configured without a change in direction, in other words at least approximately in a straight line, as is evident from FIG. 8.

In the case of these embodiment variants of the friction plate, as well, the perforations 25 described above can be provided for coolant guidance in the plate body 5, 9.

The further recesses 26 can also be used for coolant guidance. However, they can also contribute to changing the acoustic behavior of the friction plate 10.

In general, the perforations 25 and/or the further recesses 26, viewed in the axial direction 4 (FIG. 1), can have different cross-sectional shapes. For example, they can be structured to be circular or elliptical or in the shape of a polygon (quadrilateral, pentagonal, hexagonal, heptagonal, octagonal, etc.), wherein mixtures of these are also possible within a friction plate 10.

FIG. 7 shows a further embodiment variant of the friction plate 10, in which perforations 27 are also configured in the friction coating 8 (or in the friction coatings 8). With regard to the shape of these perforations 27, what was said regarding the recesses 26 applies.

The perforations 27 are disposed to be congruent with the recesses 26, in particular perforations, in the axial direction (FIG. 1), i.e. completely congruent with the recesses 26 in the axial direction 4. In this way, a coolant flow through the friction plate 10 can be achieved in the axial direction 4.

FIGS. 9 and 10 are shown embodiment variants of the friction plate 10, in which the slot-shaped recesses 14 are disposed or configured in the friction coating 8 or the friction coatings 8. The slot-shaped recesses 14 can be disposed in the friction coating 8 or the friction coatings 8 in whole or in part, wherein in the latter case, the remainder of the slot-shaped recesses is disposed or configured in the plate body 5. It is also possible that only some of the slot-shaped recesses 14 are disposed or configured in the friction coating 8 or the friction coatings 8, and the remainder of the slot-shaped recesses 14 are disposed or configured in the plate body 5.

For the case that slot-shaped recesses 14 are disposed or configured both in the friction coating 8 or the friction coatings 8 and in the plate body 5, it can be provided that these slot-shaped recesses 14 have the same geometry and/or size. It can furthermore be provided that the slot-shaped recesses 14 lie in the friction coating 8 or the friction coatings 8 above the slot-shaped recesses 14 of the plate body 5, in the axial direction 4 (FIG. 1), so that the slot-shaped recesses 14 form a continuous perforation in the axial direction 4. This can apply to all the slot-shaped recesses 14 or only some, in other words a part of the slot-shaped recesses 14.

In contrast to the above explanations regarding the slot-shaped recesses 14 in the plate body 5, the slot-shaped recesses 14 can be configured in the friction coating 8 or the friction coatings 8, beginning at the radially inner face surface and/or the radially outer face surface of the friction coating 8 or the friction coatings 8.

In FIG. 10, an alternative form of the slot-shaped recesses 14 is shown, in which these are configured in such a manner that they enclose a tongue-shaped region of the friction coating 8.

The embodiment variants of the friction plate 10 in which the slot-shaped recesses 14 are disposed or configured exclusively in the friction coating 8 or the friction coatings 8 are preferably used in the case of friction plates 10 having so-called scatter-sintered coatings.

The exemplary embodiments show possible embodiment variants, wherein it should be noted at this point that various combinations of the individual embodiment variants with one another are also possible.

For the sake of good order, it should be pointed out, in conclusion, that for a better understanding of the structure of the friction plate 10, it and its components were not necessarily represented true to scale.

### REFERENCE SYMBOL LISTING

1 plate package
2 inner plate
3 outer plate
4 axial direction
5 plate body
6 surface
7 surface
8 friction coating
9 plate body
10 friction plate
11 face surface
12 driver element
13 circumferential direction
14 recess
15 slot
16 distance
17 width
18 thickness
19 sheath
20 partial region
21 partial region
22 partial region
23 partial region
24 face surface
25 perforation
26 recess
27 perforation

1. A friction plate (10) having a ring-shaped plate body (5, 9), which is closed in the circumferential direction (13), on which body at least one friction coating (8) is disposed, if necessary, wherein the plate body (5, 9) has multiple recesses (14) in the form of perforations, and is delimited by a radially inner face surface (11) and a radially outer face surface (24), wherein the perforations are configured in slot shape, at least in part, and have multiple partial regions (20 to 23), wherein at least two partial regions (20 to 23) run in different directions relative to one another, and wherein furthermore, the slot-shaped recesses (14) are configured at a distance from the radially inner face surface (11) and the radially outer face surface (24), wherein the slot-shaped recesses (14) have a width (17) selected from a range of 50% to 150%, in particular from a range of 50% to 100%, of a thickness (18) of the plate body (5), viewed in the direction of the axial direction (4), and wherein in the embodiment variant of the plate body (5, 9) with friction coating (8), if necessary slot-shaped perforations are disposed in the friction coating (8).

2. (canceled)

3. The friction plate (10) according to claim 1, wherein the slot-shaped recesses (14) are interrupted by at least one further recess (26), not slot-shaped, in particular by a further perforation.

4. The friction plate (10) according to or claim 1, wherein at least a part of the slot-shaped recesses (14) is configured underneath the friction coating (8) in the radial direction.

5. The friction plate (10) according to claim 1, wherein at least a part of the slot-shaped recesses (14) is configured underneath the friction coating (8) in the axial direction.

6. The friction plate (10) according to claim 1, wherein at least a part of the slot-shaped recesses (14) extends continuously through the friction coating (8) and the plate body (5, 9) in the axial direction.

7. The friction plate (10) according to claim 1, wherein at least a part of the slot-shaped recesses (14) is filled, at least in part, with a material that has a lower rigidity than the plate body (5, 9).

8. A plate package (1),
comprising multiple friction plates (10) disposed one behind the other in the axial direction (4), wherein at least one of the friction plates (10) is configured according to claim 1.
